(19) United States
(12) Patent Application Publication
(10) Pub. No.: US 2007/0113180 A1
(43) Pub. Date: May 17, 2007

(54) Method and system for providing improved help functionality to assist new or occasional users of software in understanding the graphical elements of a display screen

(76) Inventor: Michael Danninger, Landau (DE)

Correspondence Address: KENYON & KENYON LLP, ONE BROADWAY, NEW YORK, NY, 10004, US

(21) Appl. No.: 11/280,074

(22) Filed: Nov. 15, 2005

(51) Int. Cl. G06F 9/00

(52) U.S. Cl. 715/705; 715/708; 715/738; 715/764

(57) ABSTRACT

A software tool allows a computer user to view at least one available explanatory balloon containing information for a particular display screen, and also enables the user to select other related help resources links within the balloons and to change the language of the text within the balloons.

### BACKGROUND OF THE INVENTION

The present invention relates to a software tool for allowing a new or occasional user to quickly familiarize himself with the functions of a given software application. Specifically, it enables the user to obtain an overview of the functionality of the software application he is using by viewing the functions of all the elements on the screen simultaneously.

Every user is, at one time, new to a particular software program. Some users become experts at certain programs through practice and frequent use. Others, however, never obtain expert status, because they use the programs infrequently. Such new or occasional users need help to navigate unfamiliar programs.

Modern software programs contain several help modes which assist users in navigating unfamiliar programs. One such help feature is the learning tutorial. When the user requests help with a certain function, the help tutorial demonstrates or explains a function in a step-by-step manner. The problem with this type of help is that it is not user friendly. Users are generally unwilling to go through guided learning tutorials, because they are time-consuming and can be difficult to understand. Additionally, help tutorials are often hard to locate within a software program.

Another help mechanism that is currently available to users is called ToolTips. ToolTips consist of text balloons that appear temporarily when the user places a mouse pointer over an icon (or active element) on the screen. These text balloons contain short statements that explain the functionality of the associated icons. The central disadvantage of ToolTips is that it can display only one text balloon at a time. In order for a user to learn the function of each active element of a display screen, he must place the mouse cursor over each such element one at a time to cause its associated text balloon to be displayed. Since only one text balloon can be displayed at a time, the user may forget the previously displayed text balloons. ToolTips thus is incapable of providing a comprehensive overview of all the active elements of a screen at the same time. Another problem with ToolTips is that the text balloon that appears when a mouse pointer is placed over an icon only displays static text explaining the icon's function. A user may wish to link to other elements that would provide further help from within the text balloon, such as a relevant URL or an explanatory multimedia presentation.

### BRIEF DESCRIPTION OF THE DRAWINGS

FIG. 1 is a simplified block diagram of a computer system according to an embodiment of the present invention;

FIG. 2 is a dataflow diagram illustrating operation of one embodiment of the present invention;

FIG. 3A is a screen shot of a computer screen;

FIG. 3B is a screen shot of a computer screen employing an embodiment of the present invention; and

FIG. 4 is a graphical representation of one explanatory balloon activated via the HelpMap feature, as referenced in FIG. 3B.

### DETAILED DESCRIPTION

Embodiments of the present invention work cooperatively with existing software applications to provide users with enhanced help functionality. A user selects the HelpMap function by way of an on-screen device, such as a toolbar icon, a menu option, or an active link. This device toggles the HelpMap feature on and off. Once the HelpMap function is selected, the CPU forwards a help request to the help module. The request includes the display context for which the call for help was made. That is, the request contains within it information indicating which active buttons (e.g. print button, line spacing button, etc.) are currently on screen. The display context consists of all the elements of the screen that are capable of performing a function and also any areas of the screen for which an explanatory balloon may be associated. For example, in Microsoft Word, the icon with a picture of a disk on it is operable to save the present document, and would be included in the request for help. Also, in a human resources context, the title “Employee Times” at the top of the screen would be included in the request. In response to the request, the help module searches a database or other memory for the explanatory balloons associated with the relevant screen elements identified in the help request. These explanatory balloons each contain a short explanatory phrase, describing the function of the associated graphical element, and at least one active element which links to a further help resource. This further help resource may be a URL or a multimedia presentation. For example, the explanatory balloon associated with the icon featuring a picture of a disk on it may contain the phrase “Save” and a link which takes the user to a URL entitled “How to Save Documents.” Also, the title “Employee Times” may have an explanatory balloon associated with it which reads “Get an overview of your team member's availability” and a link which points to a video on how to track an employee's time constraints. Once the saved explanatory balloons for the current screen are retrieved, the help module sends them to the CPU. The CPU then refreshes the display screen, including the explanatory balloons adjacent to each toolbar icon, active link, or relevant area of the display screen.

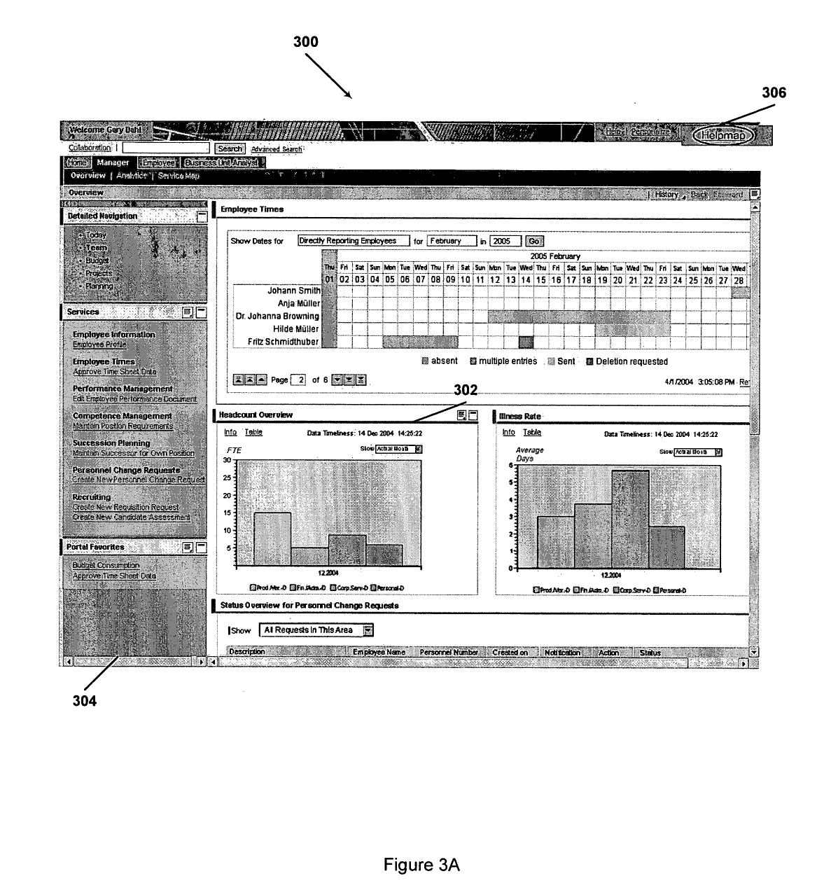

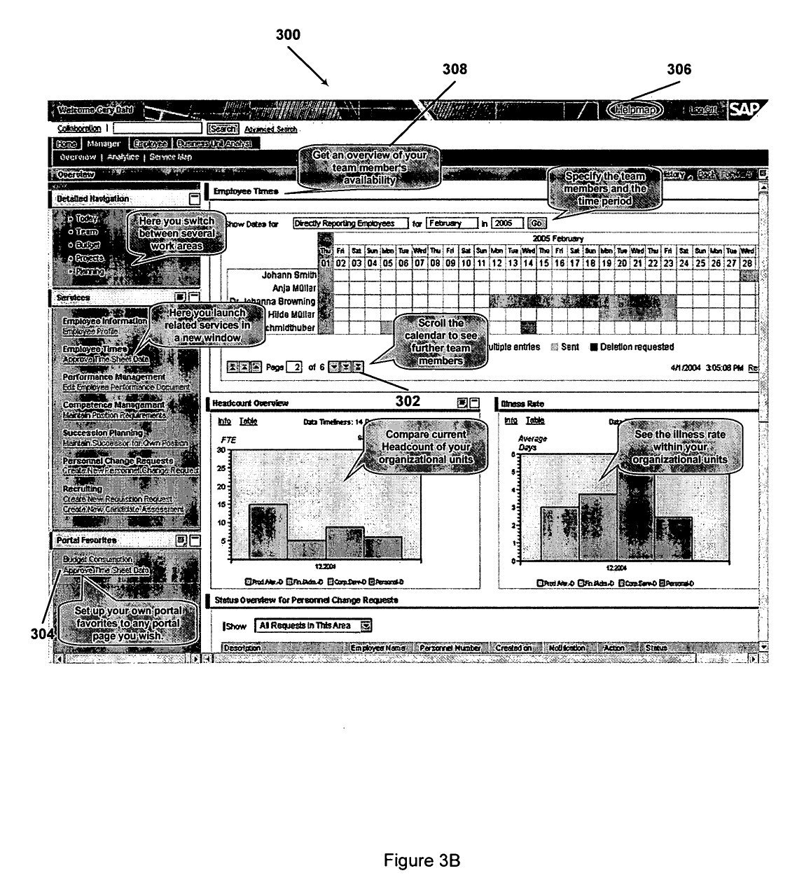

Although the present embodiment displays help resources inside explanatory balloons (see FIG. 3B), the present invention is not limited to such a graphical presentation and encompasses other modes (including audio) of communicating such help resources to the user.

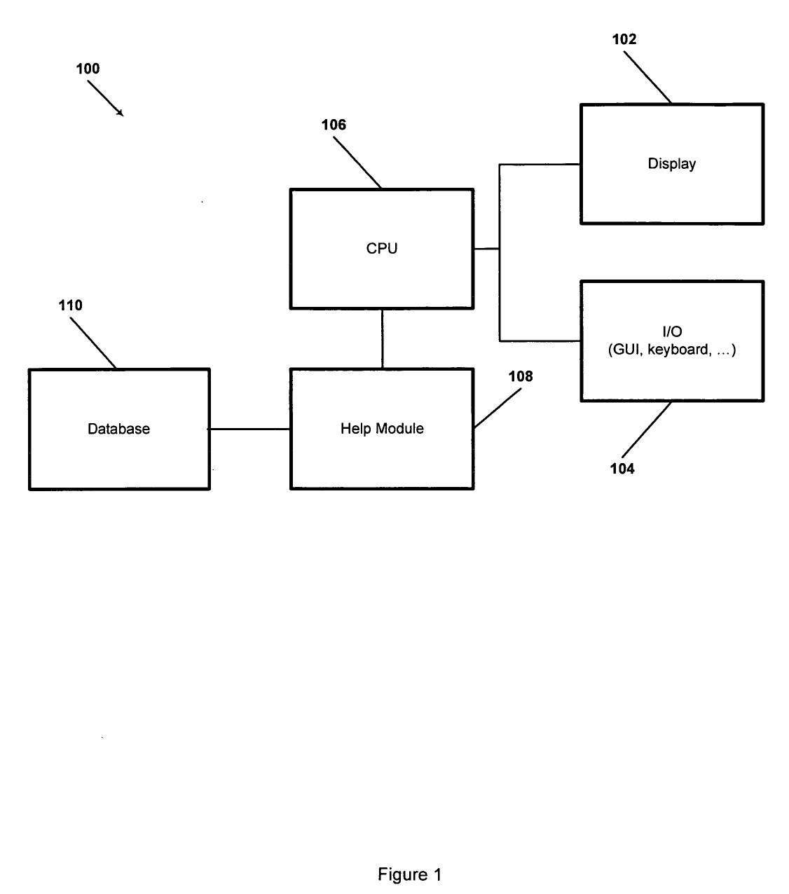

FIG. 1 is a simplified block diagram of an exemplary computer system 100 suitable for use with the present invention. The user indicates a request for help by way of an input/output device 104, such as a keyboard or a mouse, for example. The CPU 106 generates the help request and passes it onto the software help module 108, along with information indicating the active elements of the current display screen 102 for which help is requested. This request may be in the http format. The help module 108 then searches the database 110 for the saved explanatory balloons that are associated with the display screen 102 referenced in the request. The database 110 searched (which contains the saved explanatory balloons and associated information) may be an R3 database. The help module 108 may utilize ABAP software programming language to process the request, although any suitable programming software may suffice. Thereafter, the help module 108 sends the response back to the CPU 106. This response may be in http format. The response consists of at least one explanatory balloon associated with a graphical element that appeared in the display screen 102 when the request for help was placed. Each explanatory balloon, in turn, contains at least one link to a further help resource. This further help resource may be a URL or a multimedia presentation, for example. Each explanatory balloon also contains a device enabling the user to change the language of the text in that balloon. The CPU 106 refreshes the display screen 102, including the retrieved explanatory balloons. The explanatory balloons are displayed adjacent to the graphical elements which they describe. If more than one explanatory balloon is retrieved according to the user request, the explanatory balloons may be auto-arranged on the display 102 to avoid overlapping. If an explanatory balloon is overlapped, in whole or in part, by one or more other explanatory balloons, the user may click on the overlapped explanatory balloon to bring it to the foreground of the display screen in front of the one or more other explanatory balloons that had been overlapping it. This way of avoiding such overlapping balloons may be implemented through any suitable graphical technique.

In addition to requesting that all available explanatory balloons for a current screen be displayed, a user may also request that only a subset of the saved explanatory balloons be displayed. For example, a user may wish to view explanatory balloons only for icons or links pertaining to document formatting. The option for a user to choose only a subset of the available explanatory balloons may appear as a submenu to the HelpMap feature. When the user selects the HelpMap menu choice or icon, a sub-menu appears, listing several different options. For example, the following options may appear when the user selects HelpMap: Show all; File; Edit; Insert; Format. If the user wishes to see all available explanatory balloons, he would select “Show all” from the sub-menu. Alternatively, if the user wishes to see only a subset of the explanatory balloons, such as those related to document formatting, he would select “Format,” and only the explanatory balloons associated with document formatting would be displayed.

The HelpMap feature may also be configured to read out the explanatory balloons once they are displayed. In this embodiment of the present invention, the recorded voice files (which read the text of the explanatory balloons) are stored in the database 110. Each recorded voice file is associated with the explanatory balloon which it reads. The user may toggle this added feature on and off by way of an input device, such as a check box situated next to the HelpMap feature, entitled “Read HelpMap aloud.” When the user selects this check box, the request sent by the CPU 106 to the help module 108 will retrieve the voice files in addition to the explanatory balloons. Then, the voice files associated with the explanatory balloons that appear on the display 102 are played by the CPU 106. Thus, the user is able to read and simultaneously listen to the text within the explanatory balloons.

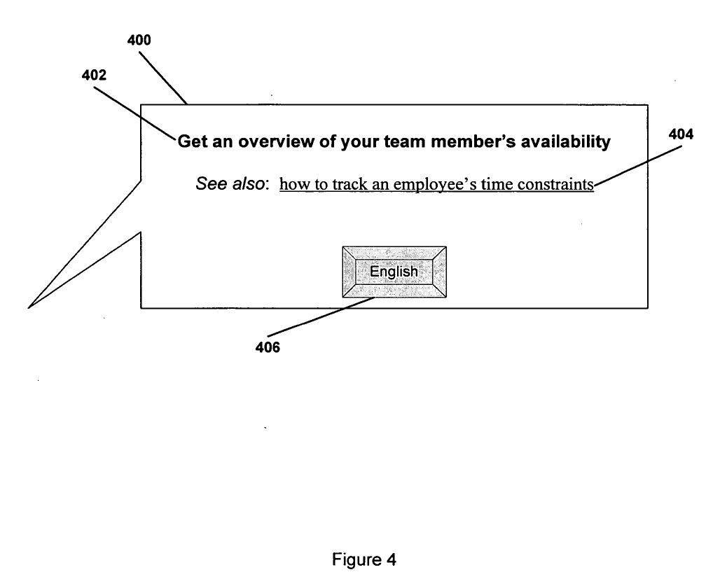

The explanatory balloons displayed by the HelpMap function may be initially displayed in the default language of the system which is selected when the user logs-in to the computer system. If the user thereafter changes the default language of the system, the explanatory balloons will be displayed in that newly chosen language. The data within each explanatory balloon is stored in many different languages in the database 110, corresponding to the different languages in which the computer system may operate. The explanatory balloons associated with the HelpMap feature may be initially displayed in whatever language the computer system is operating. Also, there may be an option within each explanatory balloon to the language in which it is displayed, which would, for example, allow a user to translate one explanatory balloon into Spanish and leave the remaining displayed explanatory balloons in English. A user may be fluent in a foreign language, such as French, and choose that foreign language to operate the computer system. However, there may be a certain explanatory balloon which the user does not understand, and would like to see in a language he is more familiar with, such as English. There may be an icon or menu option within each explanatory balloon which controls the language selection of that explanatory balloon (see FIG. 4). To implement this language translation feature, any suitable technique may be used. For instance, in database 110 each language version for each help text of each explanatory balloon may be stored in a predetermined manner. For instance, the help text “Save Document” may be saved in database 110 not only in English, but in French, Spanish, Russian, etc. The default language when a particular explanatory balloon is displayed is English, and a user could change to another prestored language for that balloon by clicking on the language icon within the explanatory balloon. Thus, the language is defaulted to the language in which the computer system is operating, but the user may change the language of any of the explanatory balloons by selecting the language menu option or icon and setting the language of that explanatory balloon himself.

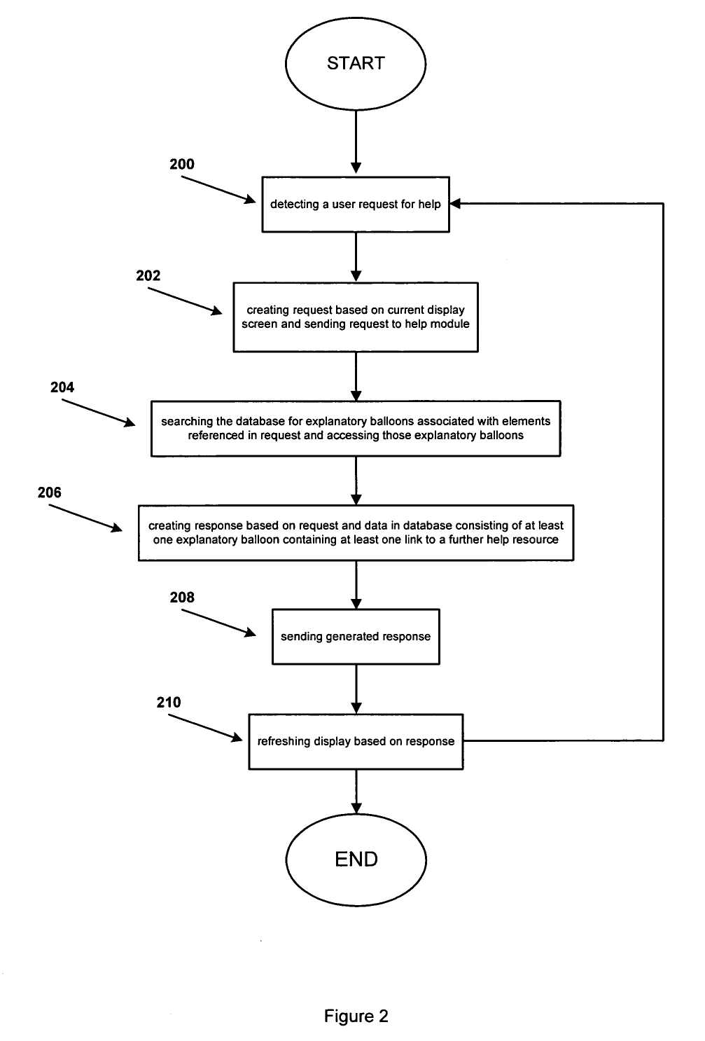

FIG. 2 is a dataflow diagram of one embodiment of the present invention. The method begins when the CPU 106 detects the user's request for help, step 200. The user may request help in several ways, such as by selecting an icon on the toolbar or by choosing help from a drop-down menu. The CPU 106 sends the user's request for help to the help module 108, including the display context for which the help request was made, step 202. Thereafter, the help module 108 searches the database 110 for explanatory balloons associated with the display elements that were referenced in the display context of the request and then accesses those explanatory balloons associated with the display elements identified in the help request, step 204. The help module 108 then creates a response based on the retrieved explanatory balloons from the database 110, step 206. This response consists of the retrieved explanatory balloons associated with the functional elements present on the display screen 102. The help module 108 sends this response to the CPU 106, step 208, and CPU 106 refreshes the display 102 to include the explanatory balloons, step 210. Any suitable technique for generating such requests and responses (for instance, requests formed in accordance with the http format) and responses may be used, and any suitable technique may be used for rendering in displayable form the data in the response pertaining to the retrieved explanatory balloons.

FIG. 3A depicts a graphical user interface of a computer screen. The computer screen 300 contains several functional elements, including icons 302 and links 304. In this computer screen, the HelpMap functionality is disabled. The top right side of this screen includes a button 306 for toggling the HelpMap functionality on and off.

FIG. 3B depicts what happens after the user clicks on button 306 in FIG. 3A. After the HelpMap functionality is turned on in this manner, the transmission and receipt of a help request and help response for the display elements currently on screen 300 take place, as discussed above. Thereafter, the help resources (text, links, language buttons, e.g.) provided in the http response for respective display elements of the current screen 300 are displayed within, for example, respective graphical explanatory balloons, each one of which is located on the screen 300 adjacent to the display element to be described thereby. Note that in this figure, even though not every element of the display screen 300 is associated with its own explanatory balloon, the present invention is capable of providing for each graphical element of the screen 300 an associated explanatory balloon. On the other hand, as explained before, clicking on button 306 may produce a sub-menu permitting the user to select for display only a subset of the explanatory balloons provided in the http response. Further, as can be seen in FIG. 3B, it is not the case that the explanatory balloons are limited to describing only active display elements such as hyperlinks or buttons. To the contrary, such explanatory balloons can describe non-interactive display elements as well, such as the bar graphs in FIG. 3B.

The explanatory balloons in FIG. 3B contain only static text, but they can be provided with active links to URLs and multimedia, such as videos, that provide supplemental assistance for understanding the associated display element. The explanatory balloons may also contain a button that calls up a menu to allow a user to change the language of the balloon to another language of his choice. Alternatively, this button may instead allow the use to toggle through a set of language in a predetermined order until arriving at the desired one.

FIG. 4 is an explanatory balloon containing text, a link to a further help resource, and a language translation button. The explanatory balloon 400 contains a short explanatory phrase 402 explaining the element's functionality. In this figure, the phrase reads “Get an overview of your team member's availability.” Additionally, the explanatory balloon also contains a link 404 entitled “how to track an employee's time constraints.” This link may point to a URL, video, or other resource providing further instruction on this topic. The language button 406 displays the name of the language in which the explanatory balloon is currently displayed. To change the language in the explanatory balloon, the user clicks on the language button 406 and chooses a new language.

What is claimed is:

1. A method of providing help information relating to display elements of a display screen, comprising:
determining which display elements are currently being displayed;
for at least one of the display elements that is currently displayed, determining a respective set of help resources, the respective set of help resources containing an actuatable element capable of changing a language of the help resources; and
providing the respective set of help resources to a device for communicating with a person.

2. The method of claim 1, wherein the determining includes receiving a user request for help.

3. The method of claim 2, wherein the user request contains a request for help resources pertaining only to a subset of the display elements currently displayed.

4. The method of claim 3, further comprising displaying the help resources pertaining to the subset.

5. The method of claim 1, further comprising displaying the set of help resources to the user.

6. The method of claim 1, wherein the set of help resources includes an active link to a further help resource.

7. The method of claim 5, wherein the set of help resources are auto-arranged on the display to avoid overlapping.

8. The method of claim 5, wherein a help resource that is overlapped by another help resource may be brought to a foreground of the display screen by being selected by the user.

9. The method of claim 6, wherein the further help resource is a URL associated with a multimedia page.

10. The method of claim 6, wherein the further help resource is a multimedia object that provides one of a video message, an audio message, and an audio-visual message.

11. An article of manufacture comprising a computer readable medium storing instructions adapted to be executed by a processor, the instructions, when executed, defining a method of providing help information relating to graphical elements of a display screen, the method comprising:
determining which display elements are currently being displayed;
for at least one of the display elements that is currently displayed, determining a respective set of help resources, the respective set of help resources containing an actuatable element capable of changing a language of the resources; and
providing the respective set of help resources to a device for communicating with a person.

12. The method of claim 11, wherein the determining includes receiving a user request for help.

13. The method of claim 12, wherein the user request contains a request for help resources pertaining only to a subset of the display elements currently displayed.

14. The method of claim 13, further comprising displaying the help resources pertaining to the subset.

15. The method of claim 11, further comprising displaying the set of help resources to the user.

16. The method of claim 11, wherein the set of help resources includes an active link to a further help resource.

17. The method of claim 15, wherein the set of help resources are auto-arranged on the display to avoid overlapping.

18. The method of claim 15, wherein a help resource that is overlapped by another help resource may be brought to a foreground of the display screen by being selected by the user.

19. The method of claim 11, wherein the further help resource is a URL associated with a multimedia page.

20. The method of claim 11, wherein the further help resource is a multimedia object that provides one of a video message, an audio message, and an audio-visual message.

21. A displayable graphical element for communicating help information, comprising:
a displayable explanatory balloon item containing text in a first language; and
an actuatable element for changing a display of the text from the first language to another language.

22. The displayable graphical element of claim 21, further comprising:
at least one active link providing access to at least one further help resource.

23. The displayable graphical element of claim 22, wherein the at least one further help resource is a URL associated with a multimedia page.

24. The displayable graphical element of claim 21, wherein the at least one further help resource is a multimedia object that provides one of a video message, an audio message, and an audio-visual message.

25. A computer system for providing help information relating to display elements of a display screen, comprising:
an arrangement for determining which display elements are currently being displayed;
for at least one of the display elements that is currently displayed, an arrangement for determining a respective set of help resources, the respective set of help resources containing an actuatable element capable of changing a language of the help resources; and
an arrangement for providing the respective set of help resources to a device for communicating with a person.

26. The computer system of claim 25, wherein the further help resource is a URL associated with a multimedia page.

27. The computer system of claim 25, wherein the further help resource is a multimedia object that provides one of a video message, an audio message, and an audio-visual message.

28. The computer system of claim 25, wherein the arrangement for providing includes a display.
